(19) United States
(12) Patent Application Publication
(10) Pub. No.: US 2026/0196931 A1
(43) Pub. Date: Jul. 9, 2026

(54) PHASE LOCKED HYBRID CONVERTER CIRCUIT

(71) Applicant: TEXAS INSTRUMENTS INCORPORATED, Dallas, TX (US)

(72) Inventors: Ronnie BEAN, Lenoir City, TN (US); Benjamin M MCCUE, Knoxville, TN (US); Ryan LIND, Knoxville, TN (US)

(21) Appl. No.: 19/010,700

(22) Filed: Jan. 6, 2025

(51) Int. Cl. H02M 3/158; H03K 3/037

(52) U.S. Cl. CPC H02M 3/158; H03K 3/037

(57) ABSTRACT

A circuit includes a fixed frequency controller, a constant on-time controller, a phase-frequency detector, and a voltage-to-current converter. The fixed frequency controller has a first control pulse output, and a clock output. The constant on-time controller has a second control pulse output, and a frequency control input. The phase-frequency detector has a first input coupled to the clock output, a second input coupled to the second control pulse output, and a phase control output. The voltage-to-current converter has a voltage input coupled to the phase control output, and a current output coupled to the frequency control input.

### BACKGROUND

A switching converter is an electronic circuit that converts an input direct current (DC) voltage into one or more DC output voltages that are higher or lower in magnitude than the input DC voltage. A switching converter that generates an output voltage lower than the input voltage is termed a buck or step-down converter. A switching converter that generates an output voltage higher than the input voltage is termed a boost or step-up converter. A switching converter that generates an output that is either higher or lower than the input voltage is termed a buck-boost converter. Switching converters are widely used to power electronic devices, particularly battery powered devices, such as portable cellular phones, laptop computers, and other electronic systems in which efficient use of power is desirable.

### SUMMARY

In one example, a circuit includes a fixed frequency controller, a constant on-time controller, a phase-frequency detector, and a voltage-to-current converter. The fixed frequency controller has a first control pulse output, and a clock output. The constant on-time controller has a second control pulse output, and a frequency control input. The phase-frequency detector has a first input coupled to the clock output, a second input coupled to the second control pulse output, and a phase control output. The voltage-to-current converter has a voltage input coupled to the phase control output, and a current output coupled to the frequency control input.

In another example, a circuit includes a first controller, a second controller, a phase-frequency detector, and a voltage-to-current converter. The first controller has a clock output and a first control pulse output. The first controller is configured to provide a fixed frequency control signal at a clock output, and provide a fixed frequency control signal at a first control pulse output. The second controller has a frequency control input and a second control pulse output. The second controller is configured to provide a constant on-time control signal at the second control pulse output. The phase-frequency detector has a first input coupled to the clock output, a second input coupled to the second control pulse output, and a phase control output coupled to the frequency control input. The phase-frequency detector is configured to provide, at the phase control output, an error signal representing a phase difference between the fixed frequency control signal and the constant on-time control signal. The voltage-to-current converter has a voltage input coupled to the phase control output, and a current output coupled to the frequency control input. The voltage-to-current converter is configured to provide a current at the current output representing the phase difference between the fixed frequency control signal and the constant on-time control signal.

In a further example, a switching converter includes a high-side transistor, a low-side transistor, an inductor, a fixed frequency controller, a constant on-time controller, a phase-frequency detector, a voltage-to-current converter, and a selector circuit. The high-side transistor has a first terminal, a second terminal, and control terminal. The first terminal of the high-side transistor is coupled to an input voltage terminal. The low-side transistor has a first terminal coupled to the second terminal of the high-side transistor, a second terminal, and a control terminal. The second terminal of the low-side transistor is coupled to a reference terminal. The inductor has a first terminal coupled to the second terminal of the high-side transistor, and a second terminal. The fixed frequency controller has a first control pulse output, and a clock output. The constant on-time controller has a second control pulse output, and a frequency control input. The phase-frequency detector has a first input coupled to the clock output, a second input coupled to the second control pulse output, and a phase control output. The voltage-to-current converter has a voltage input coupled to the phase control output, and a current output coupled to the frequency control input. The selector circuit has a first input coupled to the first control pulse output, a second input coupled to the second control pulse output, a select input, and an output coupled to the control terminal of the high-side transistor and the control terminal of the low-side transistor.

### BRIEF DESCRIPTION OF THE DRAWINGS

FIG. 1 is a block diagram of an example switching converter control circuit.

FIGS. 2A, 2B, and 2C are a schematic diagram of an example switching converter showing example circuitry of the switching converter control circuit of FIG. 1.

FIG. 3 is a graph of example signals in the switching converter of FIGS. 2A, 2B, and 2C.

FIG. 4 is a block diagram of an example battery charging system that includes an example of the switching converter of FIGS. 2A, 2B, and 2C.

### DETAILED DESCRIPTION

Applications that use a switching converter may be subject to a variety of requirements. Some applications require that the converter provide fast transient response. Some applications may require that the converter be controlled based on multiple parameters, such as input current, input voltage, output current, output voltage, temperature. A fixed frequency average current mode control circuit may satisfy the requirement for multi-parameter control by including multiple control loops directed to different parameters, and the fixed frequency aids in controlling electromagnetic interference (EMI). However, the transient response of the fixed frequency average current mode control circuit is limited (e.g., limited by the switching frequency and/or passive components of the circuit). In contrast, a constant on-time control circuit can provide good transient response, but does not have fixed frequency or provide control based on multiple parameters.

The switching converter hybrid control circuit described herein merges a fixed frequency controller and a constant on-time controller to provide fast transient response, and control based on multiple parameters. The hybrid control circuit includes a synchronization circuit that adjusts the frequency of the constant on-time controller based on the frequency of the fixed frequency controller. Because the switching frequencies of the controllers are locked, control can be passed from one controller to the other without frequency disruption. The constant on-time controller provides output voltage control to improve transient response, and the fixed frequency controller provides control based on multiple parameters. For example, the hybrid control circuit can pass control to the fixed frequency controller for control based on input current or other parameters on a cycle-by-cycle basis. Accordingly, the hybrid control circuit can provide fixed frequency control based on multiple parameters, and fast transient response.

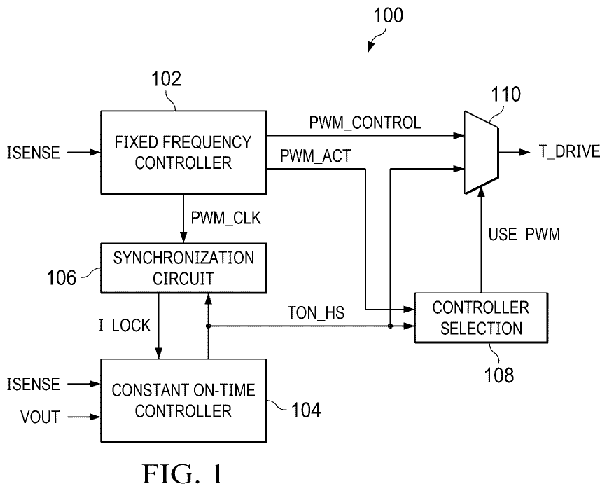

FIG. 1 is a block diagram of an example switching converter hybrid control circuit 100. The switching converter hybrid control circuit 100 includes a fixed frequency controller 102, a constant on-time controller 104, a synchronization circuit 106, a controller selection circuit 108, and selector 110. The fixed frequency controller 102 provides a fixed frequency pulse width modulation (PWM) signal (PWM_CONTROL) at a control pulse output, and provides a fixed frequency clock signal (PWM_CLK) at a clock output. PWM_CONTROL and PWM_CLK are provided at the same fixed frequency. The fixed frequency controller 102 includes PWM circuitry that generates PWM_CONTROL at the frequency of PWM_CLK with a duty cycle based on one or more control signals. FIG. 1 shows a current sense signal (ISENSE) provided at an input of the fixed frequency controller 102. ISENSE may provide a measurement of switching converter inductor current. The fixed frequency controller 102 may generate PWM_CONTROL based on ISENSE and/or other control parameters, such as output voltage, input voltage, input current, temperature, etc. The fixed frequency controller 102 also has an active output, at which a PWM active signal (PWM_ACT) is provided. PWM_ACT has a first state (e.g., a logic high state) if the fixed frequency controller 102 can control the power stage, and has a second state (e.g., a logic low state) if the fixed frequency controller 102 cannot control the power stage. The fixed frequency controller 102 may be a fixed frequency average current mode controller.

The constant on-time controller 104 provides a constant on-time control signal (TON_HS) at a control pulse output, and has inputs receiving ISENSE and switching converter output voltage (VOUT). The constant on-time controller 104 controls the frequency of TON_HS based on ISENSE and VOUT. For example, if load current increases substantially, and VOUT falls, the constant on-time controller 104 can increase the frequency of TON_HS to increase VOUT. The constant on-time controller 104 also has a frequency control input at which a lock signal (L_LOCK) is received. The constant on-time controller 104 adjusts the frequency of TON_HS to match the frequency of PWM_CLK based on I_LOCK. Because the frequency of TON_HS is locked to the frequency of PWM_CLK during steady-state operation, control can be transferred between the fixed frequency controller 102 and constant on-time controller 104 without disrupting VOUT.

The synchronization circuit 106 generates an error signal, I_LOCK, representing the difference in phase/frequency between TON_HS and PWM_CLK. The synchronization circuit 106 provides I_LOCK at a phase control output that is coupled to the frequency control input of the constant on-time controller 104. The constant on-time controller 104 receives I_LOCK, and adjusts the frequency of TON_HS to minimize the error signal.

The selector 110 selects PWM_CONTROL or TON_HS to drive power stage transistors. A selector output of the selector 110 provides a selected one of PWM_CONTROL or TON_HS as T_DRIVE to control the power stage transistors. The selector 110 has a first signal input coupled to the control pulse output of the fixed frequency controller 102, a second signal input coupled to the control pulse output of the constant on-time controller 104, and a select input.

The controller selection circuit 108 has an output at which a selector control signal USE_PWM is provided. The output of the controller selection circuit 108 is coupled to the select input of the selector 110. If USE_PWM has a first state (e.g., a logic high state), then the selector 110 provides PWM_CONTROL as T_DRIVE. If USE_PWM has a second state (e.g., a logic low state), then the selector 110 provides TON_HS as T_DRIVE. The controller selection circuit 108 has a first input coupled to the PWM active output of the fixed frequency controller 102, and a second input coupled to the control pulse output of the constant on-time controller 104. The controller selection circuit 108 may set USE_PWM based on the state of PWM_ACT and TON_HS. For example, if PWM_ACT indicates that the fixed frequency controller 102 can control the power stage, then the controller selection circuit 108 may set USE_PWM to select PWM_CONTROL at an edge of TON_HS.

In accordance with the description above, the switching converter hybrid control circuit 100 can provide fast transient response by selecting the constant on-time controller 104 to control a power stage, and provide multi-parameter control by allowing the fixed frequency controller 102 to control the power stage. Synchronization of the frequencies of the fixed frequency controller 102 and the constant on-time controller 104 allow control to be transferred between the fixed frequency controller 102 and the constant on-time controller 104 without disruption.

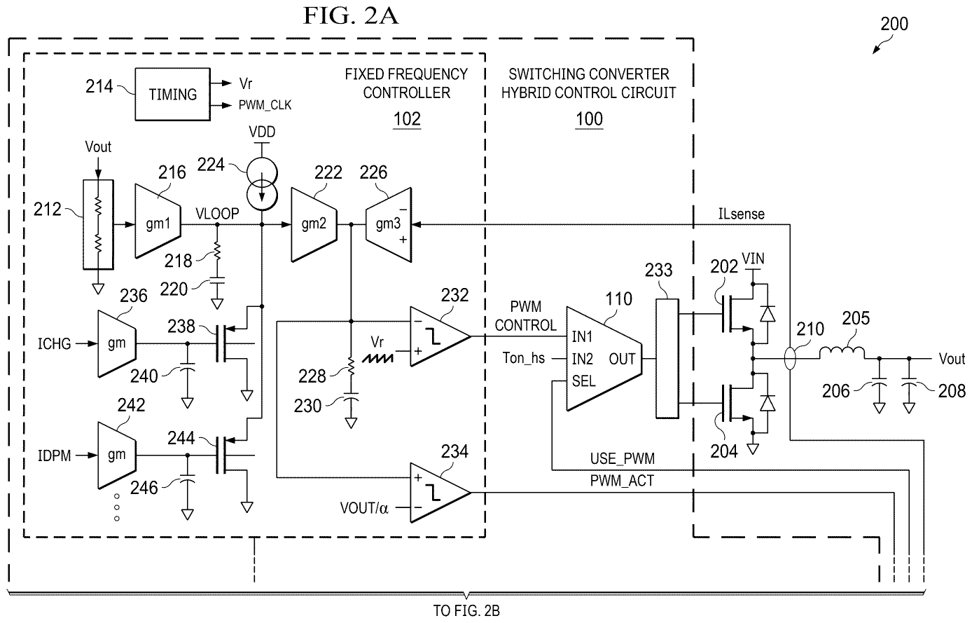

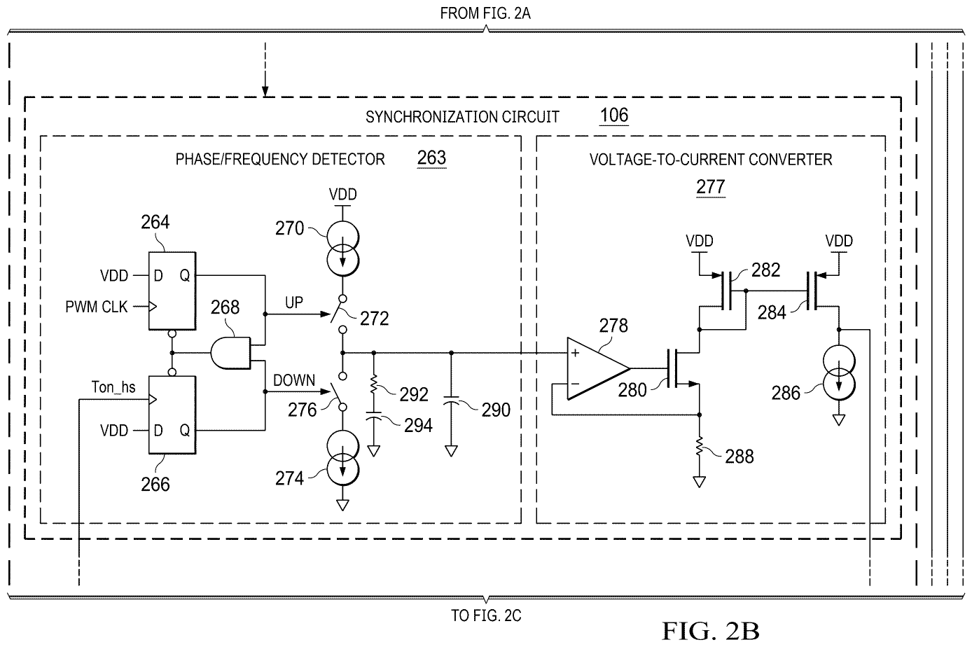

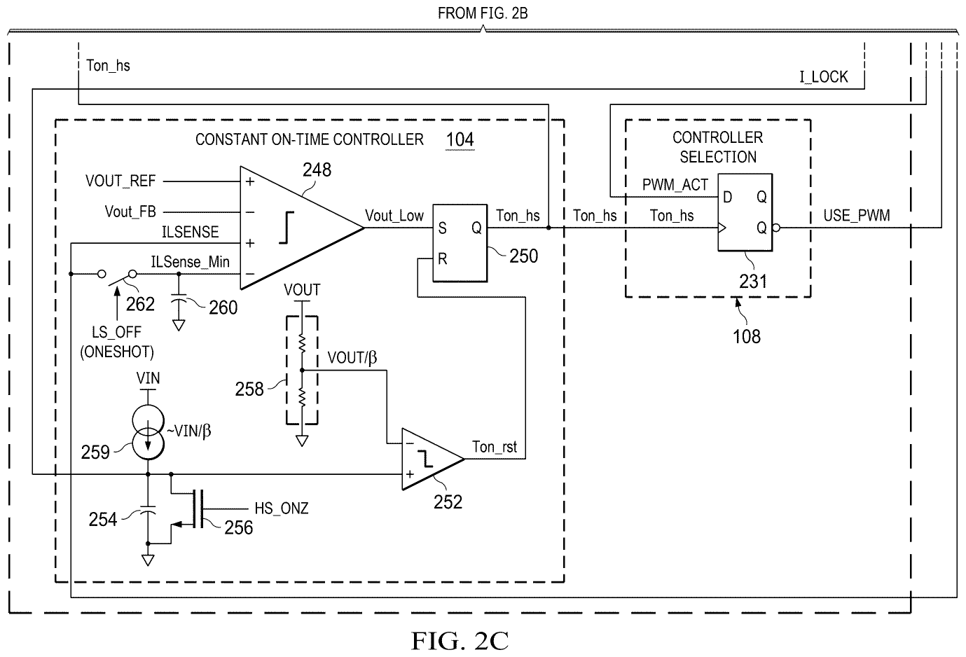

FIGS. 2A, 2B, and 2C area schematic diagram of an example switching converter 200 showing example circuitry of the switching converter hybrid control circuit 100. The switching converter hybrid control circuit 100 includes examples of the fixed frequency controller 102, the constant on-time controller 104, the synchronization circuit 106, the controller selection circuit 108, the selector 110, and a driver circuit 233. The switching converter 200 also includes a high-side transistor 202, a low-side transistor 204, an inductor 205, a capacitor 206, and a current sensor 210. The high-side transistor 202 and the low-side transistor 204 form the power stage of the switching converter 200. The high-side transistor 202 has a first terminal coupled to an input voltage terminal (VIN), a second terminal coupled to a switching terminal, and control terminal coupled to a first output of the driver circuit 233. The low-side transistor 204 has a first terminal coupled to the second terminal of the high-side transistor 202, a second terminal coupled to a reference terminal (e.g., ground), and a control terminal coupled to a second output of the driver circuit 233. The high-side transistor 202 and the low-side transistor 204 may be n-channel field effect transistors (NFETs).

The first terminal of the low-side transistor 204 is coupled to the current sensor 210 and a first terminal of the inductor 205. The current sensor 210 senses the current flowing in the inductor 205, and provides a sensed current signal (IL_SENSE) to the fixed frequency controller 102 and the constant on-time controller 104 for use in controlling the voltage at VOUT. A second terminal of the inductor 205 is coupled to an output voltage terminal (VOUT) and a first terminal of the capacitor 206. A second terminal of the capacitor 206 is coupled to the reference terminal (e.g., ground). VOUT is coupled to a load circuit 208.

The driver circuit 233 has an input coupled to the output of the selector 110. The driver circuit 233 includes circuits that receive the T_DRIVE signal from the selector 110 and generate transistor high-side and low-side drive signals at the outputs of the driver circuit 233. The circuits may provide the transistor high-side and low-side drive signals with voltage, current, dead times, and other features suitable to turn the high-side transistor 202 and the low-side transistor 204 on and off.

The selector 110 has a first input coupled to the control pulse output of the fixed frequency controller 102 for receipt of PWM_CONTROL, a second input coupled to the control pulse output of the constant on-time controller 104 for receipt of TON_HS, a select input coupled to an output of the controller selection circuit 108 for receipt of USE_PWM, and an output coupled to the input of the driver circuit 233. The selector 110 selects PWM_CONTROL or TON_HS to provide at the output of the selector 110 responsive to USE_PWM.

The fixed frequency controller 102 includes a timing circuit 214, amplifiers 216, 222, 226, 236, and 242, comparators 232 and 234, a current source 224, transistors 238 and 244, resistors 218 and 228, and capacitors 220, 230, 240, and 246. The timing circuit 214 has a first output and a second output. The timing circuit 214 provides a ramp signal (Vr) at the first output (ramp output), and a square-wave clock signal (PWM_CLK) at the second output. Vr and PWM_CLK have the same fixed frequency. The amplifier 216 has an input coupled to a voltage divider 212. The voltage divider 212 is coupled to VOUT, and may include resistors coupled in series with resistance selected to divide the voltage at VOUT by a selected divisor. The voltage divider 212 may be provided external to an integrated circuit including the fixed frequency controller 102. The output of the amplifier 216 is coupled to an input of the amplifier 222, an output of the current source 224, and resistor 218, and the transistors 238 and 244. The resistor 218 and the capacitor 220 form a compensation circuit. The resistor 218 has a first terminal coupled to the output of the amplifier 216, and a second terminal coupled to a first terminal of the capacitor 220. A second terminal of the capacitor 220 is coupled to the reference terminal (e.g., ground).

The fixed frequency controller 102 may include feedback loops for control based on a variety of parameters, such as input current, charging current (where the switching converter hybrid control circuit 100 used in a battery charger), and other parameters. FIGS. 2A, 2B, and 2C show control based on output voltage, output current, charging current, and input current. Examples of the fixed frequency controller 102 may include control based additional parameters or different parameters. The amplifier 236, the transistor 238, and the capacitor 240 provide charging current feedback. The amplifier 236 has a first input coupled to a charging current sensor (not shown), a second input coupled to a charging current reference circuit (not shown), and an output coupled to the transistor 238. The transistor 238 may be a p-channel field effect transistor (PFET). The transistor 238 has a first terminal (e.g., source) coupled to the output of the amplifier 216 to provide feedback at the input of the amplifier 222, a second terminal coupled to the reference terminal (e.g., ground), and a control terminal (e.g., gate) coupled to the output of the amplifier 236. The capacitor 240 is coupled between the output of the amplifier 236 and the reference terminal.

The amplifier 242, the transistor 244, and the capacitor 246 provide input current feedback. The amplifier 242 may be a PFET. The amplifier 242 has a first input coupled to an input current sensor (not shown), a second input coupled to an input current reference circuit (not shown), and an output coupled to the transistor 244. The transistor 244 has a first terminal (e.g., source) coupled to the output of the amplifier 216 to provide feedback at the input of the amplifier 222, a second terminal coupled to the reference terminal (e.g., ground), and a control terminal (e.g., gate) coupled to the output of the amplifier 242. The capacitor 246 is coupled between the output of the amplifier 242 and the reference terminal.

The amplifier 222 has an input coupled to the output of the amplifier 216 and an output coupled to an output of the amplifier 226. An input of the amplifier 226 is coupled to the current sensor 210. The output of the amplifier 226 and the output of the amplifier 222 are coupled to the comparators 232 and 234, and a compensation circuit including the resistor 228 and the capacitor 230. A first terminal of the resistor 228 is coupled to the output of the amplifier 226, and a second terminal of the resistor 228 is coupled to a first terminal of the capacitor 230. A second terminal of the capacitor 230 is coupled to the reference terminal (e.g., ground).

The comparator 232 provides PWM_CONTROL at the control pulse output of the fixed frequency controller 102. A first input of the comparator 232 is coupled to the output of the amplifier 226 for receipt of feedback signal provided by the amplifiers 222 and 226, and a second output of the timing circuit 214 is coupled to the first output of the timing circuit 214 for receipt of Vr. The comparator 232 compares Vr to the feedback signal to generate PWM_CONTROL. An output of the comparator 232 is coupled to the first input of the selector 110.

The comparator 234 has a first input coupled to the output of the amplifier 226 at an error signal terminal, and a second input coupled to a voltage divider (not shown) that divides the voltage at VOUT by a selected divisor (α) to generate

$$\frac{VOUT}{α} .$$

An output of the comparator 234 is coupled to the active output of the fixed frequency controller 102. The comparator 234 compares the feedback signal to

$$\frac{VOUT}{α}$$

to generate PWM_ACT.

The controller selection circuit 108 includes a flip-flop 231. The flip-flop 231 has a data input coupled to the output of the comparator 234 for receipt of PWM_ACT, and clock input coupled to the 104 for receipt of TON_HS. An output of the controller selection circuit 108 is coupled to the select input of the selector 110. If PWM_ACT is a logic high at a rising edge of TON_HS, then the flip-flop 231 sets USE_PWM to a logic low to cause the selector 110 to select PWM_CONTROL. If PWM_ACT is a logic low at the rising edge of TON_HS, then the flip-flop 231 sets USE_PWM to a logic low to cause the selector 110 to select TON_HS.

The constant on-time controller 104 provides fast response to changes in the voltage at VOUT. The constant on-time controller 104 includes comparators 248 and 252, a flip-flop 250, a transistor 256, a voltage divider 258, a current source 259, capacitors 254 and 260, and a switch 262. The comparator 248 has a first input coupled to VOUT for receipt of the feedback signal (VOUT_FB), and a second input coupled to a reference voltage terminal (VOUT_REF). VOUT_FB may be provided a voltage divider circuit, such as the voltage divider 212 or the voltage divider 258. VOUT_REF is a reference voltage provided by a reference voltage circuit (not shown). The comparator 248 compares VOUT_FB to VOUT_REF. The comparator 248 has a third input coupled to the current sensor 210 for receipt of IL_SENSE, and a fourth input coupled to the capacitor 260 and the switch 262. The switch 262 has a first terminal coupled to the fourth input of the comparator 248 and a second terminal coupled to the current sensor 210 for receipt of IL_SENSE. A control terminal of the switch 262 is coupled to a monostable circuit (not shown) that generates a pulse when the low-side transistor 204 is turned off. The capacitor 260 is coupled between the fourth input of the comparator 248 and ground. The switch 262 charges the capacitor 260 based on IL_SENSE and the pulse to generate a minimum inductor current value (IL_SENSE_MIN). The comparator 248 compares IL_SENSE to IL_SENSE_MIN. The comparator 248 has an output, and provides a set signal VOUT_LOW at the output based on the comparisons performed by the comparator 248. VOUT_LOW is set to a logic high by the comparator 248 if (VOUT_REF−VOUT_FB)>(ILSENSE−ILSENSE_MIN) to cause the flip-flop 250 to set TON_HS to a logic high.

The flip-flop 250 has a set input coupled to the output of the comparator 248 and a reset input coupled to the comparator 252. The flip-flop 250 has an output at which the flip-flop 250 provides TON_HS. The comparator 252 compares a voltage derived from VOUT to a phase error signal to generate a reset signal TON_RST provided at an output of the comparator 252. The output of the comparator 252 is coupled to the reset input of the flip-flop 250. The comparator 252 has a first input coupled to the synchronization circuit 106, and a second input coupled to the voltage divider 258. The voltage divider 258 is coupled to VOUT, and includes resistors selected to divide the voltage at VOUT by a selected divisor (β) to produce

$$\frac{VOUT}{β} ,$$

which is provided at the second input of the comparator 252. The first input of the comparator 252 is coupled to the capacitor 254, the transistor 256, and the current source 259. The current source 259 has an output coupled to the first input of the comparator 252. The capacitor 254 is coupled between the first input of the comparator 252 and the reference terminal (e.g., ground). The transistor 256 may be an NFET. The transistor 256 has a first terminal (e.g., drain) coupled to the first terminal of the comparator 252, and a second terminal coupled to the reference terminal (e.g., ground). A control terminal (e.g., gate) of the transistor 256 is coupled to the first output of the driver circuit 233 via an inverter (not shown). The output of the inverter is shown as HS_ONZ. Accordingly, the capacitor 254 is charged when the high-side transistor 202 is turned on based on current flowing from the 259 and I_KOCK, and discharged by the transistor 256 when the high-side transistor 202 is turned off.

The synchronization circuit 106 generates I_LOCK to synchronize the constant on-time controller 104 to the fixed frequency controller 102. The synchronization circuit 106 includes a phase/frequency detector 263 and a voltage-to-current converter 277. The example phase/frequency detector 263 shown in FIG. 2B includes flip-flops 264 and 266, a logic gate 268, current sources 270 and 274, switches 272 and 276, capacitors 290 and 294, and a resistor 292. The voltage-to-current converter 277 includes an amplifier 278, transistors 280, 282, and 284, a resistor 288, and a current source 286. The transistors 282 and 284 may be PFETs, and the transistor 280 may be an NFET. The phase/frequency detector 263 generates a phase error voltage. The voltage-to-current converter 277 converts the phase error voltage to the lock current I_LOCK.

In the phase/frequency detector 263, the flip-flop 264 generates a phase up signal (UP), and the flip-flop 266 generates a phase down signal (DOWN). The flip-flop 264 has a clock input coupled to the second output of the timing circuit 214, and UP is set at the rising edge of PWM_CLK. The flip-flop 266 has a clock input coupled to the output of the flip-flop 250, and DOWN is set at the rising edge of TON_HS. The logic gate 268 has a first input coupled to the output of the flip-flop 264, and a second input coupled to the output of the flip-flop 266. An output of the logic gate 268 is coupled to the reset inputs of the flip-flop 264 and the flip-flop 266 to reset the flip-flop 264 and the flip-flop 266 if either UP or DOWN is a logic low.

The switch 272 has a first terminal coupled to an output of the current source 270, and a second terminal coupled to a first terminal of the switch 276. A second terminal of the switch 276 is coupled to an input of the current source 274. A control terminal of the switch 272 is coupled to the output of the flip-flop 264, and a control terminal of the switch 276 is coupled to the output of the flip-flop 266. The capacitor 290 is coupled between the first terminal of the switch 276 and the reference terminal (e.g., ground). The resistor 292 and the capacitor 294 are coupled in series between the second terminal of the switch 276 and the reference terminal. Accordingly, if the UP signal is a logic high, then the switch 272 switches current from the current source 270 to charge the capacitor 290 and the capacitor 294. If the DOWN signal is a logic high, then the switch 276 discharges the capacitor 290 and the capacitor 294 through the current source 274. Some examples of the phase/frequency detector 263 include components and connections that different from those described herein while providing an error voltage similar to that provided by the described circuitry.

In the voltage-to-current converter 277, the amplifier 278 has a first input (a voltage input) coupled to the second terminal of the switch 276 (a control voltage output), and a second input coupled to a first terminal of the resistor 288. A second terminal of the resistor 288 is coupled to the reference terminal (e.g., ground). An output of the amplifier 278 is coupled to a control terminal (e.g., gate) of the transistor 280. The transistor 280 has a first terminal (e.g., source) coupled to the second terminal of the amplifier 278. The amplifier 278 causes the transistor 280 to draw a current such that the voltage across the 288 is equal to the voltage at the first input of the amplifier 278 (control voltage output by the phase/frequency detector 263).

The transistors 282 and 284 are coupled as a current mirror. A first terminal (e.g., source) of the transistor 282 is coupled to a power terminal, and a second terminal (e.g., drain) of the transistor 282 is coupled to a second terminal (e.g., drain) of the transistor 280 and a control terminal (e.g., gate) of the transistor 282. A first terminal (e.g., source) of the transistor 284 is coupled to the power terminal, and a second terminal (e.g., drain) of the transistor 284 is coupled to an input of the current source 286 and the first input of the comparator 252. The second terminal of the transistor 284 is the current output of the voltage-to-current converter. A control terminal (e.g., gate) of the transistor 284 is coupled to the control terminal of the transistor 282. An output of the current source 286 is coupled to the reference terminal (e.g., ground). I_LOCK is provided at the second terminal of the transistor 284.

I_LOCK adjusts the voltage at the first terminal of the comparator 252 to synchronize TON_HS provided by the constant on-time controller 104 with PWM_CLK provided by the fixed frequency controller 102. Synchronization of the constant on-time controller 104 with the fixed frequency controller 102 allows control of the power stage to be transferred between the constant on-time controller 104 and the fixed frequency controller 102 without disruption in operational frequency.

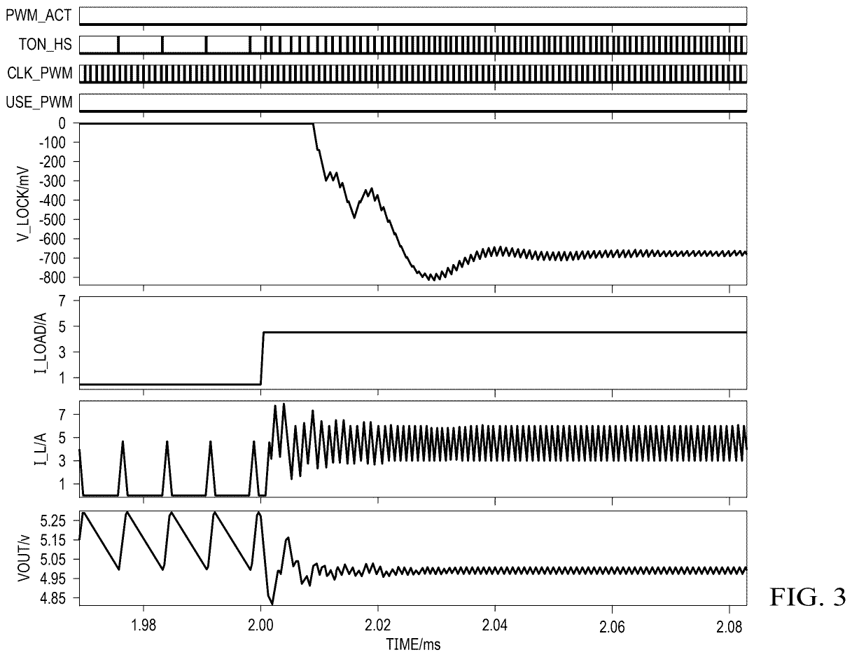

FIG. 3 is a graph of example signals in the switching converter 200. FIG. 3 shows PWM_ACT, TON_HS, CLK_PWM, and USE_PWM in the switching converter hybrid control circuit 100. FIG. 3 also shows examples of the voltage at the first input of the comparator 252 (V_LOCK), current drawn by the load circuit 208 (V_LOAD), current flowing in the inductor 205 (I_L), and voltage at VOUT (VOUT). In FIG. 3, the fixed frequency controller 102 is inactive (PWM_ACT and USE_PWM are logic low), and the constant on-time controller 104 is controlling the power stage. At about 2 milliseconds (ms), I_LOAD increases from less than 1 ampere (A) to over 4 A. While I_LOAD is low (before time 2 ms), the constant on-time controller 104 is running free, and provides operation similar to pulse frequency modulation. This operation is shown by the period of TON_HS, the I_L current pulses, and the VOUT ripple frequency. During this interval, the constant on-time controller 104 is not being synchronized to PWM_CLK. For example, the synchronization circuit 106 may include a comparator (not shown) that compares average inductor current (e.g., average ILSENSE) to a threshold. If the average inductor current is below the threshold, then synchronization of the constant on-time controller 104 to the PWM_CLK may be disabled to allow the constant on-time controller 104 to provide PFM operation.

When I_LOAD increases (at time 2 ms), VOUT drops, and the constant on-time controller 104 increases the frequency of TON_HS to increase I_L. The synchronization circuit 106 is activated and provides I_LOCK to synchronize the constant on-time controller 104 to PWM_CLK. Accordingly, V_LOCK falls between times 2.01 ms and 2.03 ms, and stabilizes at about time 2.04 ms when TON_HS is locked to CLK_PWM.

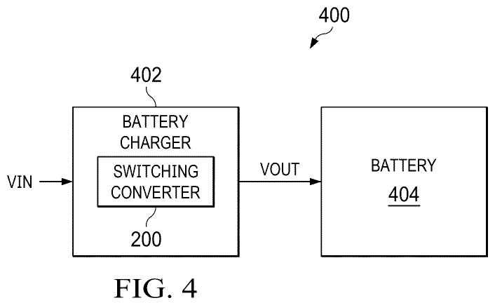

FIG. 4 is a block diagram of an example battery charging system 400. The battery charging system 400 includes a battery charger 402 and a battery 404. The battery charger 402 may be a universal serial bus power delivery (USB-PD) based battery charger in some examples. The battery charger 402 includes an example of the switching converter 200 that converts an input voltage (VIN) to VOUT for use in charging the battery 404. The constant on-time controller 104 provides fast transient response, and the fixed frequency controller 102 provides control based on multiple parameters (e.g., input current, input voltage, output voltage, charging current, temperature, or other parameters). Because the switching frequency of the constant on-time controller 104 is locked to the switching frequency of the fixed frequency controller 102 control can be transferred between the constant on-time controller 104 and the fixed frequency controller 102 while maintaining a fixed frequency.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET)) (p-type transistor)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “abut,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a fixed frequency controller having a first control pulse output, and a clock output;
a constant on-time controller having a second control pulse output, and a frequency control input;
a phase-frequency detector having a first input coupled to the clock output, a second input coupled to the second control pulse output, and a phase control output; and
a voltage-to-current converter having a voltage input coupled to the phase control output, and a current output coupled to the frequency control input.

2. The circuit of claim 1, further comprising a selector circuit having a first input coupled to the first control pulse output, a second input coupled to the second control pulse output, a select input, and a selector output.

3. The circuit of claim 2, wherein the constant on-time controller includes:
a flip-flop having a set input, a reset input, and an output coupled to the second control pulse output;
a first comparator having a first input coupled to an output voltage terminal, a second input coupled to a reference voltage terminal, and an output coupled to the set input;
a second comparator having a first input coupled to an output voltage terminal, a second input coupled to the current output, and an output coupled to the reset input;
a current source having an output coupled to the second input of the second comparator;
a capacitor coupled between the second input of the second comparator and a reference terminal; and
a transistor having a first terminal coupled to the second input of the second comparator, a second terminal coupled to the reference terminal, and a control terminal coupled to the selector output.

4. The circuit of claim 2, further comprising a controller selection circuit having an output coupled to the select input, the controller selection circuit configured to select a first control pulse provided at the first control pulse output, or a second control pulse provided at the second control pulse output to drive a power stage.

5. The circuit of claim 4, wherein:
the fixed frequency controller has an active output; and
the controller selection circuit includes a flip-flop having a clock input coupled to the second control pulse output, a data input coupled to the active output, and an output coupled to the select input.

6. The circuit of claim 5, wherein the fixed frequency controller has an active output coupled to the data input.

7. The circuit of claim 5, wherein the fixed frequency controller includes:
a timing circuit having a ramp output, and a clock output coupled to the clock output of the fixed frequency controller;
a first comparator having a first input coupled to an output voltage terminal, a second input coupled to an error signal terminal, and an output coupled to the data input; and
a second comparator having a first input coupled to the ramp output, a second input coupled to the error signal terminal, and an output coupled to the first control pulse output.

8. A circuit comprising:
a first controller having a clock output and a first control pulse output, the first controller configured to:
provide a fixed frequency control signal at the clock output; and
provide a fixed frequency control signal at the first control pulse output;
a second controller having a frequency control input and a second control pulse output, the second controller configured to provide a constant on-time control signal at the second control pulse output; and
a phase-frequency detector having a first input coupled to the clock output, a second input coupled to the second control pulse output, and a phase control output coupled to the frequency control input, the phase-frequency detector configured to provide, at the phase control output, an error signal representing a phase difference between the fixed frequency control signal and the constant on-time control signal.

9. The circuit of claim 8, further comprising a voltage-to-current converter having a voltage input coupled to the phase control output, and a current output coupled to the frequency control input, the voltage-to-current converter configured to provide a current at the current output representing a phase difference between the fixed frequency control signal and the constant on-time control signal.

10. The circuit of claim 8, wherein the second controller is configured to adjust a frequency of the constant on-time control signal to be the same as a frequency of the fixed frequency control signal responsive to the error signal.

11. The circuit of claim 8, further comprising a selector circuit having a first signal input coupled to the first control pulse output, a second signal input coupled to the second control pulse output, a select input, and a selector output, the selector circuit configured to
provide the fixed frequency control signal responsive to a selector control signal received at the select input having a first state; and
provide the constant on-time control signal responsive to the selector control signal having a second state.

12. The circuit of claim 11, further comprising a controller selection circuit having an output coupled to the select input, and an input coupled to an active output of the first controller, the controller selection circuit configured to select the fixed frequency control signal or the constant on-time control signal to drive a power stage based on an active signal received at the input of the controller selection circuit.

13. The circuit of claim 12, wherein the controller selection circuit includes a flip-flop having a data input coupled to the active output, a clock input coupled to the second control pulse output, and an output coupled to the select input.

14. The circuit of claim 8, wherein the first controller is configured to:
generate a ramp signal having a same frequency as the fixed frequency control signal;
compare a converter output voltage to an error signal, the error signal based on the converter output voltage and sensed converter current; and
compare the error signal to the ramp signal to generate the fixed frequency control signal.

15. The circuit of claim 8, wherein the second controller is configured to:
compare a converter output voltage to a reference voltage to generate a set signal;
generate a control voltage based on the error signal;
compare the converter output voltage to the control voltage to generate a reset signal; and
set the constant on-time control signal to a first state responsive the set signal, and set the constant on-time control signal to a second state responsive to the reset signal.

16. A switching converter comprising:
a high-side transistor having a first terminal coupled to an input voltage terminal, a second terminal, and control terminal;
a low-side transistor having a first terminal coupled to the second terminal of the high-side transistor, a second terminal coupled to a reference terminal, and a control terminal;
an inductor having a first terminal coupled to the second terminal of the high-side transistor, and a second terminal;
a fixed frequency controller having a first control pulse output, and a clock output;
a constant on-time controller having a second control pulse output, and a frequency control input;
a phase-frequency detector having a first input coupled to the clock output, a second input coupled to the second control pulse output, and a phase control output;
a voltage-to-current converter having a voltage input coupled to the phase control output, and a current output coupled to the frequency control input; and
a selector circuit having a first input coupled to the first control pulse output, a second input coupled to the second control pulse output, a select input, and an output coupled to the control terminal of the high-side transistor and the control terminal of the low-side transistor.

17. The switching converter of claim 16, further comprising a controller selection circuit having an output coupled to the select input, the controller selection circuit configured to select a first control signal provided at the first control pulse output, or a second control signal provided at the second control pulse output to drive the high-side transistor and the low-side transistor.

18. The switching converter of claim 17, wherein:
the controller selection circuit includes a flip-flop having a clock input coupled to the second control pulse output, a data input, and an output coupled to the select input; and
the fixed frequency controller has an active output coupled to the data input.

19. The switching converter of claim 18, wherein the fixed frequency controller includes:
a timing circuit having a ramp output, and a clock output coupled to the clock output of the fixed frequency controller;
a first comparator having a first input coupled to the second terminal of the inductor, a second input coupled to an error signal terminal, and an output coupled to the data input; and
a second comparator having a first input coupled to the ramp output, a second input coupled to the error signal terminal, and an output coupled to the first control pulse output.

20. The switching converter of claim 16, wherein the constant on-time controller includes:
a flip-flop having a set input, a reset input, and an output coupled to the second control pulse output;
a first comparator having a first input coupled to the second terminal of the inductor, a second input coupled to a reference voltage terminal, and an output coupled to the set input;
a second comparator having a first input coupled to the second terminal of the inductor, a second input coupled to the current output, and an output coupled to the reset input;
a current source having an output coupled to the second input of the second comparator;
a capacitor coupled between the second input of the second comparator and a reference terminal; and
a transistor having a first terminal coupled to the second input of the second comparator, a second terminal coupled to the reference terminal, and a control terminal coupled to the output of the selector circuit.
